(19) United States
(12) Patent Application Publication
(10) Pub. No.: US 2021/0221318 A1
(43) Pub. Date: Jul. 22, 2021

(54) Cover Material for Covering an Airbag Unit

(71) Applicant: Konrad Hornschuch AG, Weissbach (DE)

(72) Inventors: Gabriele Wittmann, Oehringen (DE); Birgit Kammerer, Kupferzell (DE); Sonja Kaspar, Krautheim-Neunstetten (DE); Matthias Knecht, Oehringen (DE); Barbara Knerr, Niedernhall (DE)

(73) Assignee: ContineKonrad Hornschuch AG, Weissbach (DE)

(21) Appl. No.: 16/967,454

(22) PCT Filed: Jan. 7, 2019
(86) PCT No.: PCT/EP2019/050193

§ 371 Date: Aug. 5, 2020

(30) Foreign Application Priority Data
Feb. 6, 2018 (DE) 10 2018 102 632.3

(51) Int. Cl. B60R 21/215; D06N 3/00; D06N 3/06; D06N 3/14; D06N 3/18

(52) U.S. Cl. CPC B60R 21/215; D06N 3/0077; D06N 3/06; D06N 3/144; D06N 3/145; D06N 2211/263; D06N 3/0006; D06N 3/0009; D06N 3/0011; D06N 2203/042; D06N 2209/10; D06N 3/183

(57) ABSTRACT

The invention relates to a cover material for covering an airbag unit, comprising a textile carrier material (1) composed of threads and comprising a coating (2) based on thermoplastic materials applied to the textile carrier material (1) on the visible side, wherein the textile carrier material (1) has, in a longitudinal direction (L) and/or in the transverse direction (Q) orthogonal with respect thereto, linear regions (100) of lower strength than in the remaining regions (101), which linear regions form weakening lines (30) for the cover material (3), and along the weakening lines (30) the cover material has an ultimate tensile strength of 150 to 700 N and a tear propagation resistance of 3 to 45 N.

The invention relates to a cover material for covering an airbag unit, such as is used for example in motor vehicle interiors as a cover fabric or surface material for instrument panels, door linings, seat structures and the like, in order to conceal an airbag unit under an optically appealing surface.

In order to ensure the airbag function with such cover materials, it is required that the cover material either has from the outset a visible opening line for the deployment of the airbag, although this is optically undesired, or else the cover material is designed to be weakened in the region of the desired opening line in order to allow the deployment of the airbag. This weakening of the material has required up until now additional work steps, such as for example laser machining or a cold-knife cut, entailing undesired effort and moreover running the risk that the weakening lines become visible, which is undesirable for optical reasons.

It is additionally known from DE 10 2004 010 359 A1 and EP 1 436 175 B1 to produce the cover material from a textile woven fabric or knitted fabric in which one or more threads of lower tear resistance are incorporated in the region of the desired weakening lines in order to define the desired weakening lines or predetermined breaking point. However, it is required here to precisely fix the position of the weakened thread to be incorporated only in the region of the desired weakening lines and to exactly position at the subsequent installation site the textile cover material created in such a way to ensure that the weakening lines come into the desired overlap with the edge of the covered airbag unit. Moreover, there is no provision in the known prior art to form the cover material from an optically advantageous imitation leather; rather, the textile cover material forms the visible surface.

It is an object of the invention to propose a cover material of the type stated at the outset that is formed in the manner of an artificial leather with a leather-like surface, can be produced in a simple and efficient manner and moreover, without the risk of visible weakening lines or the requirement for subsequently incorporated weakening lines, ensures the desired deployment of the covered airbag unit.

To achieve the set object, a cover material according to the features of patent claim 1 is proposed according to the invention.

Advantageous embodiments and developments of the invention are the subject of the dependent claims.

Starting from an artificial leather structure known per se having a textile carrier material composed of threads and having a coating based on thermoplastic materials applied firmly adhered to the textile carrier material on the visible side, the invention proposes to form the textile carrier material in such a way that it has, in a longitudinal direction and/or in the transverse direction orthogonal with respect thereto, a multiplicity of linear regions of lower strength than in the remaining regions. After the application of the coating, these linear regions of lower strength form in the obtained cover material according to the invention externally nonvisible weakening lines for the cover material, since the coating is applied homogeneously to the textile carrier material and covers the linear regions of lower strength contained therein. However, these linear regions of lower strength in the textile carrier material result in the fact that the obtained cover material has, in the region of the weakening lines defined by the linear regions of lower strength, along the longitudinal extent of said weakening lines, an ultimate tensile strength of only 150-700 N and a tear propagation resistance of 3-45 minutes, whereas the corresponding values outside of the weakening lines of the cover material according to the invention are considerably higher.

It is accordingly the case that, along the weakening lines, the strength of the cover material according to the invention, depending on the course of the linear regions of lower strength in the textile carrier, is reduced only in its longitudinal direction and/or in the transverse direction with respect thereto in such a way that, upon triggering of a covered airbag unit, the cover material reliably tears open along the weakening line.

Since there is provision within the scope of the invention to provide a multiplicity of such linear regions of lower strength within the textile carrier material, the cover material can be positioned in virtually any desired manner with respect to the airbag unit to be covered since, by selecting a sufficiently small distance between the individual linear regions, a suitable overlap with the airbag unit to be covered is always ensured. The cover material according to the invention can thus be individually separated efficiently from web material in virtually any desired manner to form the respectively required component blanks.

Moreover, the cover material according to the invention allows extraordinary design freedom and variety, since the possible blanks from the web material can have very tight radii. In addition, the cover material according to the invention can be stitched without problem. Hence, the cover material according to invention as flat product can be further processed and used unstitched, for example as a punched part directly, or else in complex form stitched to form the sewn covering. Complex designs with tight radii can be produced.

There is provision according to the invention that the weakening lines are positioned running parallel at a distance of approximately 0.5-500 mm from one another, with it being possible in particular to provide a regularly repeating grid-like arrangement of the weakening lines.

There can furthermore be provision that the cover material has an ultimate tensile strength elongation of approximately 3-200% along the weakening lines in order to effectively assist the tear-open process.

In order, in the case of the triggering of the covered airbag unit, to allow no separation between the textile carrier material and the coating applied on the visible side to occur that can lead for example to dangerous flying particles, there is moreover provision that the separating force required to separate the carrier material from the coating in a temperature range between −40° C. and 120° C. is greater than 18 N/5 m. This temperature range represents the to-be-expected use range in the context of a motor vehicle within which the strength values already explained above in the region of the weakening lines must also be observed.

According to a further proposal of the invention, the cover material according to the invention has a weight per unit area of overall approximately 300-1200 g/m² in order to ensure good processability.

According to one proposal of the invention, the linear regions of lower strength of the textile carrier material can be formed by using threads in these linear regions that are thinner and/or have lower strength. Alternatively, instead of using different threads or yarns, it is also possible to influence the strength by changing the structure of the textile carrier material in the linear regions of lower strength, for example by processing in the manner of a net fabric, etc.

In each case, the resultant linear weakening of the strength in the overall assembly of the cover material according to invention in the longitudinal and/or transverse direction (uni- or bidirectionally) produces the desired tear-open functionality with respect to the covered airbag unit. Here, the linear weakening is not visually apparent on the surface of the cover material according to the invention.

According to one proposal of the invention, the textile carrier material of the cover material according to the invention can be formed on the basis of threads or yarns composed of polyester, polyamide, polyacetate, rayon, viscose and/or cotton. Corresponding threads or yarns composed of other renewable raw materials also come into consideration. The threads or yarns can be processed as a woven fabric, knitted fabric or nonwoven to form the textile carrier material.

According to a further proposal of the invention, the cover material according to the invention has an overall thickness of approximately 0.5 to 5 mm, of which approximately 0.1 to 4.8 mm are accounted for by the coating and correspondingly 0.2 to 4.9 mm by the textile carrier material.

The coating of the cover material according to the invention can be formed in a manner known per se for example on the basis of PVC, a polyurethane or else a thermoplastic polyolefin, that is to say a mixture of a polyolefin-based plastic (usually PP) and an elastomer, such as for example EPDM, or mixtures thereof.

The coating can be formed on the textile carrier material either in one layer or in the form of a plurality of identical or different discrete successive layers. Here, either crosslinked or noncrosslinked plastics can be used to form the individual layers, with its also being possible for compact and foamed structures to be provided to form the individual layers. In the case of an individual layer, the layer thickness can be up to 4.8 mm and, in the case of a multilayered formation of the coating, an individual layer can be formed starting from approximately 1 μm layer thickness.

It is considered expedient within the scope of the invention to form the coating in a layer number between 1 and 10.

Furthermore, at least one varnish layer can be applied to the coating on the visible side in order to realize desired functional layers (for example with respect to abrasion resistance, water-repelling properties) or printed layers for a desired coloring. Within the scope of the invention, up to 6 printed layers are considered to be expedient.

Moreover, the visible-side surface of the cover material according to the invention can be provided with a profiling, for example an embossing in the manner of a leather grain. Such an embossing can be formed for example by vacuum embossing, embossing between steel roller pairs and by building up the coating on a detachable profiled base, for example a release paper or a steel embossing strip in the so-called reverse process.

The invention will be explained in further detail below on the basis of the drawing and the exemplary embodiments. In the drawing:

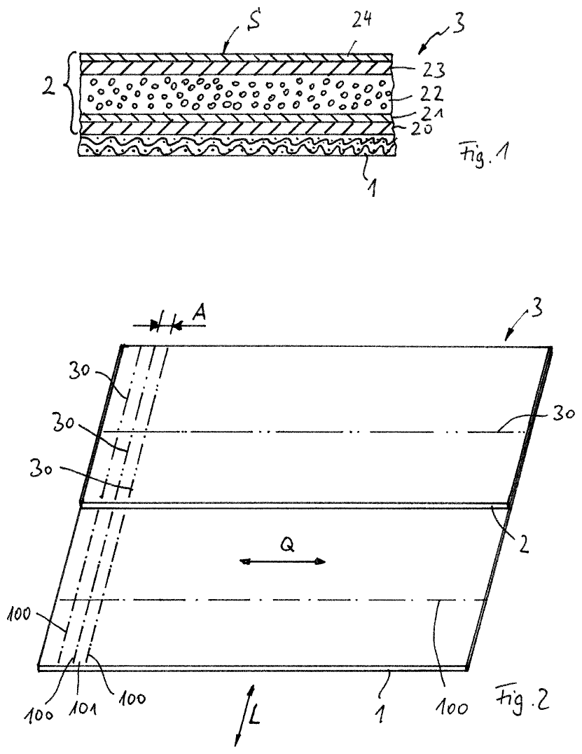

FIG. 1 is a greatly enlarged schematic illustration showing a section through a cover material according to the invention;

FIG. 2 is a schematic perspective illustration showing a partially sectioned construction of the cover material according to the invention.

FIG. 1 illustrates in a cross section a cover material 3 for covering an airbag unit (not shown here) in a motor vehicle interior, for example in the region of the dashboard.

The cover material has on its bottom side a textile carrier material 1 which is formed for example from polyester threads in the form of a woven fabric with warp threads running in a longitudinal direction L and weft threads running in a transverse direction Q; see FIG. 2.

A multilayered coating 2 is applied to this textile carrier material 1, with the layer coming to lie directly on the textile carrier material 1 being denoted by reference sign 20 and the subsequent layer applied discretely thereon being denoted by reference sign 21. These layers are for example compact layers on the basis of PVC or polyurethane, with in particular the layer 20 being tailored in its formulation in such a way that it enters into particularly intimate adhesion with the underlying textile carrier material 1, specifically at least in a temperature range between −40° C. and 120° C. The adhesion achieved brings about separating forces between the textile carrier material 1 and the coating of considerably more than 18 N/5 m.

A foamed layer 22, for example likewise on the basis of PVC or polyurethane, is applied to the compact layer 21 and imparts a pleasant soft and elastic feel to the entire coating 2. Above the foamed layer 22 there adjoins a further compact layer 23 composed of compatible plastic. The uppermost layer 24, which also forms the visible surface or visible side S, can be formed for example by a printed layer which, moreover, can also be provided with a surface profiling, for example in the form of a leather grain. Hence, the cover material 3 can be classified as artificial leather.

As can be seen in particular from the further illustration according to FIG. 2, linear regions 100 of lower strength than in the remaining regions 101 are formed in the textile carrier material 1 along the longitudinal direction L and also along the transverse direction Q orthogonal with respect thereto, said linear regions running parallel to one another and having for example a regular distance A from one another of approximately 1 mm. These linear regions 100 of lower strength are formed by virtue of the fact that the warp threads or weft threads each lying on the linear regions 100 have a lower strength than those threads which are woven in the remaining regions 101 to form the textile carrier material 1. This can be realized for example by using threads of smaller diameter in relation to the remaining regions 101. Although not illustrated for reasons of clarity, the linear regions 100 can be arranged at regular intervals over the entire longitudinal and/or transverse direction (L, Q).

The textile carrier material 1 thus has, along the linear regions 100 of lower strength at the desired spacing A, linear weakened regions which, after the coating 2 has been applied to the textile carrier material 1 to form the cover material 3, define weakening lines 30 within the obtained cover material 3 which run exactly along the course of the linear regions 100 of lower strength in the textile carrier 1. However, by virtue of the homogeneous coating 2 on the visible side of the textile carrier 1, they are not visually evident.

In the region of these weakening lines 30, the cover material 3 has an ultimate tensile strength of only 150-700 N, a tear propagation resistance of 3-45 N and an ultimate tensile strength elongation of 3-200% along the course of the weakening lines 30. Depending on the positioning, the latter can run either along the longitudinal direction L or along the transverse direction Q or both along the longitudinal direction L and the transverse direction Q.

However, when placing such a cover material 3 on an airbag unit (not shown here) for covering the latter, one of these weakening lines 30 comes reliably into overlap with the periphery of the airbag unit as a result of the small spacing A of the individual weakening lines 30 and causes the cover material to tear open along this weakening line 30 upon triggering of the airbag. No particular requirements or specifications are therefore placed on the positioning of the cover material 3 with respect to the course of the weakening lines 30 in relation to the airbag unit to be covered, which considerably simplifies the application and processing.

However, the by contrast considerably higher strength of the cover material 3 outside the weakening lines 30 ensures sufficient stability and stitchability of the cover material 3 for applications in the motor vehicle interior.

Further details become evident from the exemplary embodiments specified below, which nevertheless serve only to illustrate the invention and are not intended to limit it in any way:

For the formation of cover materials for covering an airbag unit in motor vehicle interiors, cover materials were produced from a bottom-side textile carrier material and coatings applied on the upper side in various embodiments and tested with regard to their tear-open properties.

The textile carrier material used was either a warp-knit material composed of 100% polyacetate fibers with a weight of 50-350 g/m² and a thickness of 0.2-1.2 mm or a circular-knit material composed of 100% polyester fibers with a weight of 50-350 g/m² and a thickness of 0.20-1.20 mm, in each case having linear regions of lower strength both in the longitudinal and transverse direction (Example 1) on the one hand and only in the transverse direction (Example 2) on the other hand and provided with the following examples of a coating.

PVC-based coating

| | | Example 1 | | Example 2 | |
|---|---|---|---|---|---|
| Total weight: | | 770 | g/m² | 740 | g/m² |
| Total thickness: | | 1.0 | mm | 1.15 | mm |
| Burning: | | <100 | mm/min | <100 | mm/min |
| Tear propagation resistance: | L | 10 | N | 60 | N |
| | Q | 9 | N | 15 | N |

| | | | |
|---|---|---|---|
| Ultimate tensile strength: | L | 290 N/5 cm | 350 N/5 cm |
| | Q | 200 N/5 cm | 200 N/5 cm |
| Ultimate tensile strength | L | 25% | 50% |
| elongation: | Q | 37% | 167% |
| Separating force: | | >18 N/5 mm | >18 N/5 mm |

PUR-based coating

| | | Example 1 | | Example 2 | |
|---|---|---|---|---|---|
| Total weight: | | 530 | g/m² | 630 | g/m² |
| Total thickness: | | 0.9 | mm | 1.05 | mm |
| Burning: | | <100 | mm/min | <100 | mm/min |
| Tear propagation resistance: | L | 9 | N | 55 | N |
| | Q | 7 | N | 12 | N |

| | | | |
|---|---|---|---|
| Ultimate tensile strength: | L | 270 N/5 cm | 330 N/5 cm |
| | Q | 180 N/5 cm | 210 N/5 cm |
| Ultimate tensile strength | L | 20% | 54% |
| elongation: | Q | 31% | 155% |
| Separating force: | | >18 N/5 mm | >18 N/5 mm |

TPO-based coating

| | | Example 1 | | Example 2 | |
|---|---|---|---|---|---|
| Total weight: | | 600 | g/m² | 650 | g/m² |
| Total thickness: | | 1.0 | mm | 1.05 | mm |
| Burning: | | <100 | mm/min | <100 | mm/min |
| Tear propagation resistance: | L | 11 | N | 63 | N |
| | Q | 10 | N | 10 | N |

| | | | |
|---|---|---|---|
| Ultimate tensile strength: | L | 300 N/5 cm | 370 N/5 cm |
| | Q | 220 N/5 cm | 220 N/5 cm |
| Ultimate tensile strength | L | 30% | 45% |
| elongation: | Q | 29% | 153% |
| Separating force: | | >18 N/5 mm | >18 N/5 mm |

The cover materials obtained had a leather grain structure and could be finished by stitching as an artificial leather cover material for dashboards, door side linings and seat linings for covering airbag units in the motor vehicle interior, and ensured, without fixed positioning with respect to the airbag unit to be covered, a reliable tear-open behavior to deploy the airbag.

1.-13. (canceled)

14. A cover material for covering an airbag unit, comprising a textile carrier material composed of threads and comprising a coating based on thermoplastic materials applied to a textile carrier material on a visible side, wherein the textile carrier material has, in a longitudinal direction (L) and/or in the transverse direction (Q) orthogonal with respect thereto, linear regions of lower strength than in remaining regions, wherein the linear regions form weakening lines for the cover material, and along the weakening lines the cover material has an ultimate tensile strength of from 150 to 700 N and a tear propagation resistance of from 3 to 45 N.

15. The cover material as claimed in claim 14, wherein the weakening lines run parallel at a distance of 0.5 to 500 mm from one another.

16. The cover material as claimed in claim 14 having an ultimate tensile strength elongation of from 3 to 200% along the weakening lines.

17. The cover material as claimed in claim 14, wherein a separating force required to separate the textile carrier material from the coating in a temperature range between −40° C. and 120° C. is greater than 18 N/5 m.

18. The cover material as claimed in claim 14 having a weight per unit area of 300 to 1200 g/m².

19. The cover material as claimed in claim 14, wherein in the linear regions of lower strength, the textile carrier material comprises threads which are thinner than in the remaining regions.

20. The cover material as claimed in claim 14, wherein in the linear regions of lower strength, the textile carrier material comprises threads which have a lower strength than in the remaining regions.

21. The cover material as claimed in claim 14, wherein the textile carrier material is formed on the basis of threads composed of polyester, polyamide, polyacetate, rayon, viscose and/or cotton.

22. The cover material as claimed in claim 21, wherein the textile carrier material is a woven fabric, knitted fabric or nonwoven.

23. The cover material as claimed in claim 14, wherein the textile carrier material has a thickness of 0.2 to 4.9 mm.

24. The cover material as claimed in claim 14, wherein the coating is formed on the basis of polyvinyl chloride (PVC), polyurethane (PUR), thermoplastic polyolefin (TPO), or mixtures thereof.

25. The cover material as claimed in claim 14, wherein the coating comprises a plurality of discrete successive layers.

26. The cover material as claimed in claim 14, wherein at least one varnish layer is applied to the coating on the visible side.

27. The cover material as claimed in claim 14, wherein the total thickness of the cover material is from 0.5 mm to 5 mm.

28. The cover material as claimed in claim 14 provided with a profiling at least in the region of the visible side.

29. The cover material as claimed in claim 14, wherein the coating has a thickness of from 0.1 to 4.8 mm.

30. The cover material as claimed in claim 14, wherein the textile carrier material has a thickness of from 0.2 to 4.9 mm.

31. The cover material as claimed in claim 14, wherein the textile carrier material is a warp-knit material composed of polyacetate fibers with a weight of 50-350 g/m² and a thickness of 0.2-1.2 mm.

32. The cover material as claimed in claim 14, wherein the textile carrier material is a circular-knit material composed of 100% polyester fibers with a weight of 50-350 g/m² and a thickness of 0.20-1.20 mm

33. The cover material as claimed in claim 14, wherein the coating is formed on the basis of polyurethane (PUR).
